(19) United States
(12) Patent Application Publication
(10) Pub. No.: US 2013/0083233 A1
(43) Pub. Date: Apr. 4, 2013

(54) IMAGE PICKUP UNIT

(71) Applicant: Tadashi Fukami, Kanagawa (JP)

(72) Inventor: Tadashi Fukami, Kanagawa (JP)

(73) Assignee: SONY CORPORATION, Tokyo (JP)

(21) Appl. No.: 13/617,995

(22) Filed: Sep. 14, 2012

(30) Foreign Application Priority Data
Oct. 4, 2011 (JP) 2011-220230

(51) Int. Cl. H04N 5/225

(52) U.S. Cl. 348/360; 348/E05.024

(57) ABSTRACT

An image pickup unit includes: an image pickup lens; a perspective splitting device splitting a light beam that has passed through the image pickup lens into light beams corresponding to a plurality of perspectives different from one another; an image pickup device having a plurality of pixels, and receiving the light beams that have passed through the perspective splitting device, by each of the pixels, to obtain pixel signals based on an amount of the received light; and a correction section performing correction for suppressing crosstalk between perspectives with use of a part or all of the pixel signals obtained from the plurality of pixels.

### CROSS REFERENCES TO RELATED APPLICATIONS

The present application claims priority to Japanese Priority Patent Application JP 2011-220230 filed in the Japan Patent Office on Oct. 4, 2011, the entire content of which is hereby incorporated by reference.

### BACKGROUND

This disclosure relates to an image pickup unit using a lens array.

In the past, various image pickup units have been proposed and developed (“Light Field Photography with a Hand-Held Plenoptic Camera”, Ren. Ng, et al., Stanford Tech Report CTSR 2005-02). In addition, an image pickup unit in which an image signal is subjected to a predetermined image processing and then is output has been proposed. For example, in Japanese Unexamined Patent Application Publication No. 2009-021683 and “Light Field Photography with a Hand-Held Plenoptic Camera”, Ren. Ng, et al., Stanford Tech Report CTSR 2005-02, an image pickup unit using a method called “Light Field Photography” is disclosed. The image pickup unit includes a lens array disposed between an image pickup lens and an image sensor. A light beam coming from a subject is split into light beams corresponding to respective perspectives by the lens array, and then the split light beams are received by the image sensor. Multi-perspective images are generated at a time with use of pixel signals provided from the image sensor.

### SUMMARY

In the image pickup unit described above, each light beam which has passed through one lens of the lens array is received by m×n pieces (m and n are each an integer of 1 or larger, except for m=n=1) of pixels on the image sensor. Therefore, perspective images for the number (m×n pieces) of pixels corresponding to respective lenses are obtainable.

Accordingly, if relative displacement occurs between the lens array and the image sensor, the light beams corresponding to different perspectives are received by one pixel, resulting in crosstalk of the light beams (hereinafter, referred to as crosstalk between perspectives, or simply referred to as crosstalk). Such crosstalk between perspectives causes image quality deterioration such as double image of the subject, and thus is desirably suppressed.

It is desirable to provide an image pickup unit capable of reducing image quality deterioration caused by crosstalk between perspectives.

According to an embodiment of the disclosure, there is provided an image pickup unit including: an image pickup lens; a perspective splitting device splitting a light beam that has passed through the image pickup lens into light beams corresponding to a plurality of perspectives different from one another; an image pickup device having a plurality of pixels, and receiving the light beams that have passed through the perspective splitting device, by each of the pixels, to obtain pixel signals based on an amount of the received light; and a correction section performing correction for suppressing crosstalk between perspectives with use of a part or all of the pixel signals obtained from the plurality of pixels.

In the image pickup unit according to the embodiment of the disclosure, the light beam which has passed through the image pickup lens is split into light beams corresponding to the plurality of perspectives by the perspective splitting device, and then received by each pixel of the image pickup device. As a result, the pixel signal based on the amount of received light is obtainable. When relative displacement between the perspective splitting device and the image pickup device occurs, the crosstalk between perspectives occurs due to the displacement. The correction for suppressing the crosstalk between perspectives is allowed to be performed with use of a part or all of the pixel signals obtained from respective pixels.

In the image pickup unit according to the embodiment of the disclosure, the light beam which has passed through the image pickup lens is split into light beams corresponding to the plurality of perspectives by perspective splitting device, and then received by each pixel of the image pickup device. As a result, a pixel signal based on the amount of the received light is obtainable. Even when relative displacement between the perspective splitting device and the image pickup device occurs, the crosstalk between perspectives is allowed to be suppressed through the correction using a part or all of the pixel signals obtained from respective pixels. As a result, image quality deterioration caused by the crosstalk between perspectives is allowed to be suppressed.

Additional features and advantages are described herein, and will be apparent from the following Detailed Description and the figures.

### BRIEF DESCRIPTION OF THE FIGURES

The accompanying drawings are included to provide a further understanding of the disclosure, and are incorporated in and constitute a part of this specification. The drawings illustrate embodiments and, together with the specification, serve to explain the principles of the technology.

FIG. 1 is a diagram illustrating a general configuration of an image pickup unit according to an embodiment of the disclosure.

FIG. 2 is a schematic diagram illustrating an ideal arrangement of an image sensor and a lens array.

FIG. 3 is a schematic diagram for explaining perspective splitting.

FIG. 4 is a schematic diagram illustrating an image pickup signal provided from the image sensor.

FIGS. 5A to 5I are schematic diagrams for explaining each perspective image generated based on the image pickup signal illustrated in FIG. 3.

FIGS. 6A to 6I are schematic diagrams each illustrating an example of the perspective image.

FIG. 7 is a schematic diagram illustrating relative displacement (displacement caused along an X direction) between the image sensor and the lens array.

FIG. 8 is a schematic diagram of light beams entering each pixel in the case where the displacement of FIG. 7 occurs.

FIG. 9 is a block diagram for explaining a functional structure of a CT correction section.

FIGS. 10A to 10C each illustrate an example of a matrix operation expression of linear transformation in each line along the X direction.

FIGS. 11A and 11B are schematic diagrams for explaining derivation of a representation matrix in the case of focusing on a set of pixel signals in a central line in the X direction.

FIG. 12 is a schematic diagram illustrating relative displacement (in a Y direction) between an image sensor and a lens array according to a modification 1.

FIGS. 13A to 13C each illustrate an example of a matrix operation expression of linear transformation in each line along the Y direction.

FIG. 14 is a schematic diagram illustrating relative displacement (displacement caused on an XY plane) between an image sensor and a lens array according to a modification 2.

### DETAILED DESCRIPTION

Hereinafter, a preferred embodiment of the disclosure will be described in detail with reference to drawings. Note that the description will be given in the following order.
1. Embodiment (Example of an image pickup unit in which linear transformation is performed on a set of pixel signals of each line along an X direction)
2. Modification 1 (Example in the case where each line along a Y direction is a target of correction)
3. Modification 2 (Example in the case where each line in the X direction and the Y direction is a target of correction)

### Embodiment

[General Configuration]

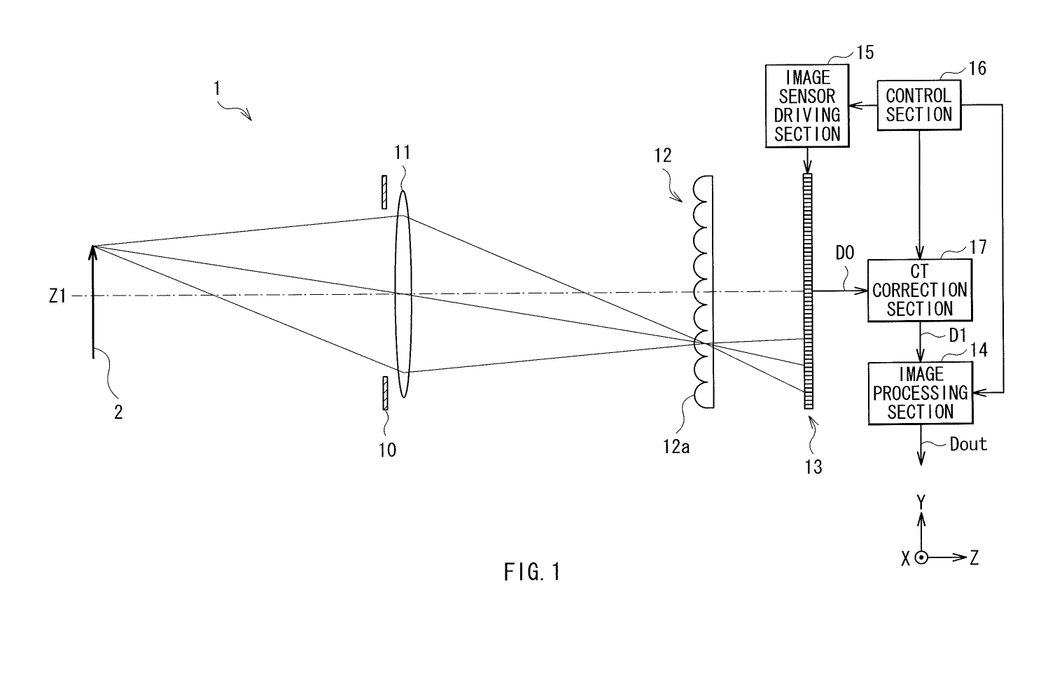

FIG. 1 illustrates a general configuration of an image pickup unit (an image pickup unit 1) according to an embodiment of the disclosure. The image pickup unit 1 is a so-called monocular light field camera which takes an image of a subject 2 and performs predetermined processing on the image to output images corresponding to a plurality of perspectives (image signal Dout). The image pickup unit 1 includes an image pickup lens 11, a lens array 12, an image sensor 13, an image processing section 14, an image sensor drive section 15, a crosstalk (CT) correction section 17, and a control section 16. Note that, in the following description, a direction along an optical axis Z1 is Z, and in a plane orthogonal to the optical axis Z1, a horizontal direction (lateral direction) is X, and a perpendicular direction (vertical direction) is Y.

The image pickup lens 11 is a main lens for taking an image of the subject 2, and is configured of a general image pickup lens used in a video camera, a still camera, and the like. An aperture stop 10 is provided on a light incident side (or a light emission side) of the image pickup lens 11.

The lens array 12 is a perspective splitting device which is disposed on an imaging surface (a focal plane) of the image pickup lens 11 and splits an incident light beam into light beams corresponding to different perspectives in a pixel unit. In the lens array 12, a plurality of microlenses 12a is two-dimensionally arranged along the X direction (a row direction) and the Y direction (a column direction). Such a lens array 12 enables perspective splitting for the number of pixels ((the number of all pixels in the image sensor 13)/(the number of lenses in the lens array 12)) allocated to each microlens 12a. In other words, perspective splitting is achievable within a range of pixels (a matrix region U described later) allocated to one microlens 12a, in a pixel unit. Note that the “perspective splitting” means recording of information including the region through which the light has passed, of the image pickup lens 11, and its directionality, in a pixel unit of the image sensor 13. The image sensor 13 is disposed on the imaging surface of the lens array 12.

The image sensor 13 has a plurality of pixel sensors (hereinafter, simply referred to as pixels) arranged in a matrix, for example, and receives light beams which have passed through the lens array 12 to acquire an image pickup signal D0. The image pickup signal D0 is a so-called RAW image signal which is a set of electric signals (pixel signals) each indicating the intensity of light received by each of the pixels on the image sensor 13. The image sensor 13 includes the plurality of pixels arranged in a matrix (along the X direction and the Y direction) and is configured of a solid-state image pickup device such as a charge coupled device (CCD) image sensor or a complementary metal-oxide semiconductor (CMOS) image sensor. For example, a color filter (not shown) may be provided on a light incident side (a side closer to the lens array 12) of the image sensor 13.

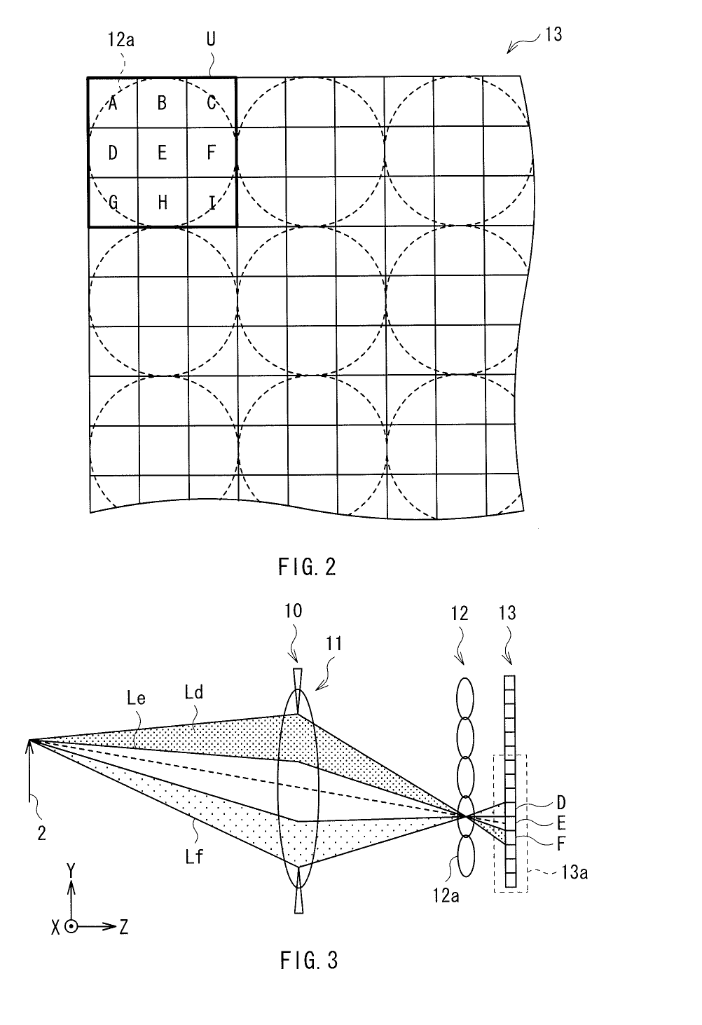

FIG. 2 illustrates an example of an ideal arrangement of the lens array 12 and the image sensor 13 (without relative displacement). In this example, pixels A to I arranged in 3×3 on the image sensor 13 are allocated to one microlens 12a. Accordingly, light beams which have passed through each of the microlenses 12a are received by the image sensor 13 while being subjected to the perspective splitting in each pixel A to I unit in the matrix region U.

The image processing section 14 performs predetermined image processing on the image pickup signal D0 provided from the image sensor 13, and outputs the image signal Dout as a perspective image, for example. The image processing section 14 includes, for example, a perspective image generation section and an image correction processing section. The image correction processing section performs demosaic processing, white balance adjusting processing, gamma correction processing, and the like. Although the detail will be described later, the perspective image generation section synthesizes (rearranges) selective image signals of the image pickup signal D0 obtained corresponding to the pixel arrangement to generate a plurality of perspective images different from one another.

The image sensor drive section 15 drives the image sensor 13 to control exposure and readout thereof

The CT correction section 17 is an operation processing section performing correction for suppressing crosstalk between perspectives. Incidentally, in the present specification and the disclosure, the crosstalk between perspectives means that light beams corresponding to different perspectives are received by one pixel, namely, that perspective splitting is not performed sufficiently and thus light beams corresponding to different perspectives are mixedly received. The crosstalk between perspectives is caused by a distance between the lens array 12 and the image sensor 13 and a relative positional relationship between the image sensor 13 and the lens array 12. In particular, when the relative positional relationship between the image sensor 13 and the lens array 12 is not aligned to the ideal arrangement of FIG. 2, namely, when positional displacement occurs, the crosstalk between perspectives is likely to occur. Alternatively, the crosstalk between perspectives is affected by three-dimensional relative positional relationship between the image sensor 13 as well as the lens array 12 and the image pickup lens 11, formation accuracy of the microlenses 12a, and the like. The CT correction section 17 performs linear transformation on a set of the selective pixel signals of the image pickup signal D0 provided from the image sensor 13 to perform correction for suppressing the crosstalk between perspectives described above. The detailed functional structure and the detailed correction operation of the CT correction section 17 will be described later.

The control section 16 controls operation of each of the image processing section 14, the image sensor driving section 15, and the CT correction section 17, and is configured of, for example, a microcomputer.

[Function and Effect]

[Acquisition of Image Pickup Signal]

In the image pickup unit 1, the lens array 12 is provided on the imaging surface of the image pickup lens 11 and the image sensor 13 is provided on the imaging surface of the lens array 12. With this configuration, a light beam of the subject 2 is recorded in each pixel of the image sensor 13, as a light beam vector holding information about the intensity distribution and the progress direction (perspective) of the light beam. Specifically, each of the light beams which has passed through the lens array 12 is split into light beams for respective perspectives, and the split light beams are received by different pixels of the image sensor 13.

For example, as illustrated in FIG. 3, of light beams which have passed through the image pickup lens 11 and entered the microlens 12a, light beams (light fluxes) Ld, Le, and Lf corresponding to different perspectives are received by different three pixels (D, E, and F), respectively. In this way, in the matrix region U allocated to the microlens 12a, light beams corresponding to different perspectives are received by respective pixels. The image sensor 13 performs readout line-sequentially according to the drive operation by the image sensor driving section 15, and the image pickup signal D0 is acquired. Incidentally, at this time, in the embodiment, signal is read out in a line basis along the X direction of the image sensor 13, and the image pickup signal D0 is acquired as a set of the line signals configured of pixel signals arranged along the X direction.

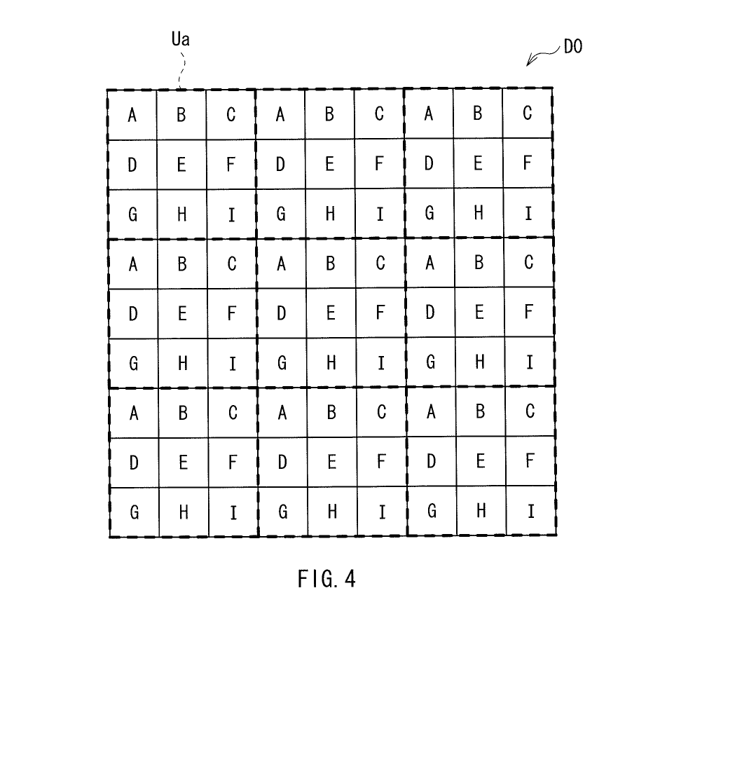

FIG. 4 schematically illustrates the image pickup signal D0 (the RAW image signal) obtained in this way. In the case where 3×3 matrix region U is allocated to one microlens 12a as in the embodiment, in the image sensor 13, light beams corresponding to nine perspectives in total are received by different pixels (pixel sensors) A to I, respectively, for each matrix region U. Therefore, the image pickup signal D0 includes the pixel signal having 3×3 arrangement (Ua in FIG. 4), which corresponds to the matrix region U. Incidentally, in the image pickup signal D0 of FIG. 4, numerals corresponding to the pixels A to I are affixed to respective pixel signals for description. The pixel signal obtained from each of the pixels A to I is recorded as a color signal corresponding to the color arrangement of the color filter (not shown) provided on the image sensor 13. The image pickup signal D0 having such pixel signals is output to the CT correction section 17.

Although the detail will be described later, the CT correction section 17 performs correction for suppressing crosstalk between perspectives, with use of a part or all of the pixel signals of the image pickup signal D0. The image pickup signal after crosstalk correction (the image pickup signal D1) is output to the image processing section 14.

[Generation of Perspective Image]

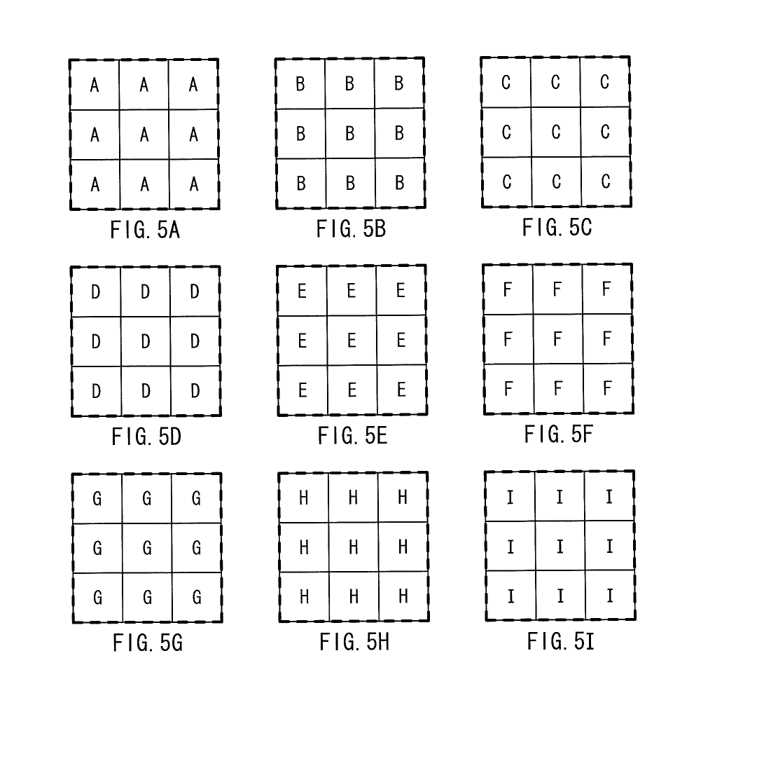

The image processing section 14 performs predetermined image processing on the image pickup signal (the image pickup signal D1 output from the CT correction section 17) based on the image pickup signal D0 to generate a plurality of perspective images. Specifically, the image processing section 14 synthesizes the pixel signals of the image pickup signal D0, which are extracted from the pixels at the same position of respective matrix regions U (rearranges respective pixel signals in the image pickup signal D1). For example, in the arrangement of the RAW image data illustrated in FIG. 4, the image processing section 14 synthesizes pixel signals obtained from the pixel A in each matrix region U (FIG. 5A). The similar processing is applied to the pixel signals obtained from each of the other pixels B to I (FIGS. 5B to 5I). In this way, the image processing section 14 generates the plurality of perspective images (herein, nine perspective images) based on the image pickup signal D1. The perspective images generated in such a way are output as the image signal Dout to the outside or a storage section (not shown). Note that, actually, although each pixel data contains a signal component of a light beam which is intended to be received by an adjacent pixel as will be described later, each perspective image is represented with use of the pixel data A to I in FIGS. 5A to 5I for description.

Incidentally, the image processing section 14 may perform, on the above-described perspective images, other image processing, for example, color interpolation processing such as demosaic processing, white balance adjusting processing, and gamma correction processing, and may output the perspective image signal after such image processing as the image signal Dout. The image signal Dout may be output to the outside of the image pickup unit 1, or may be stored in a storage section (not shown) provided inside the image pickup unit 1.

Incidentally, the above-described image signal Dout may be a signal corresponding to the perspective image or the image pickup signal D0 before perspective image generation. In other words, the image pickup signal (the image pickup signal D1 after crosstalk correction) still having the signal arrangement read out from the image sensor 13 may be output to the outside without being subjected to the perspective image generation processing (rearrangement processing of the pixel signals), or may be stored in a storage section.

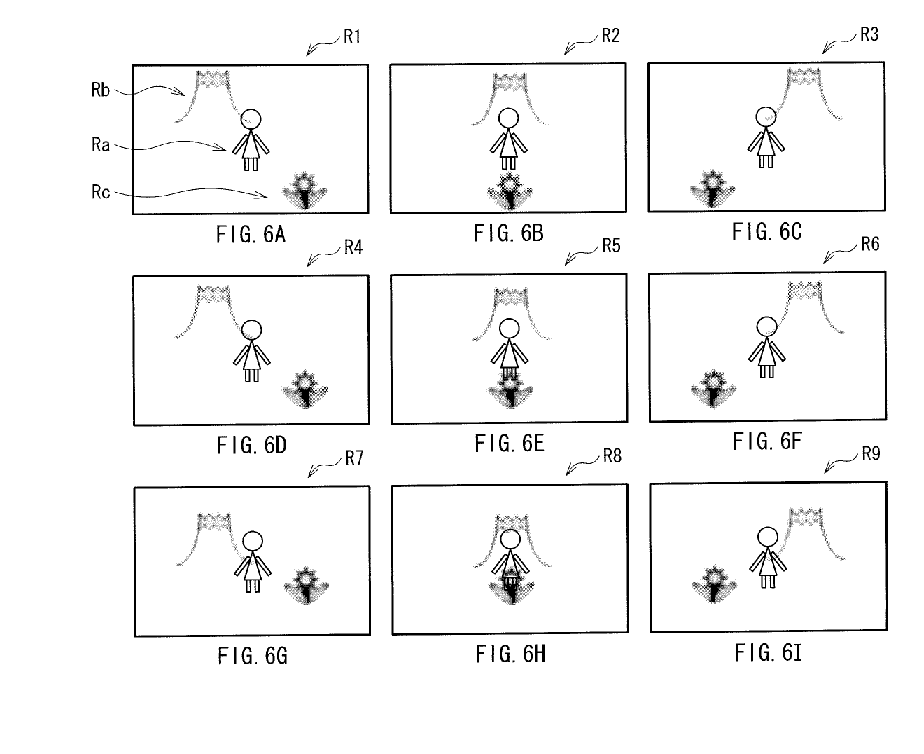

FIGS. 6A to 6I each illustrates an example of the perspective images (perspective images R1 to R9) corresponding to the signal arrangement of FIGS. 5A to 5I. As the image of the subject 2, illustrated are images Ra, Rb, and Rc of three subjects “person”, “mountain”, and “flower” placed at different positions in a depth direction. The perspective images R1 to R9 are captured while the image pickup lens focuses on “person” out of the three subjects, and in the images R1 to R9, the image Rb of “mountain” behind “person” and the image Rc of “flower” in front of “person” are defocused. In the monocular image pickup unit 1, the focused image Ra of “person” does not shift even if the perspective changes. However, each of the defocused images Rb and Rc shifts to different positions depending on the perspectives. Note that, in FIGS. 6A to 6I, the positional shift between perspective images (positional shift of the images Rb and Rc) are illustrated in an exaggerated manner.

These nine perspective images R1 to R9 are usable for various applications, as multi-perspective images having parallax therebetween. Of the perspective images R1 to R9, for example, two perspective images corresponding to a left perspective and a right perspective are used to perform stereoscopic image display. For example, the perspective image R4 illustrated in FIG. 6D is usable as a left perspective image, and the perspective image R6 illustrated in FIG. 6F is usable as a right perspective image. Such two perspective images of left and right are displayed using a predetermined stereoscopic display system so that “mountain” is observed visually farther than “person” and “flower” is observed visually nearer than “person”.

Herein, in the image pickup device 1, as described above, the matrix region U of the image sensor 13 is allocated to one microlens 12a of the lens array 12, and receives light to perform perspective splitting. Therefore, each microlens 12a and the matrix region U are desirably aligned with high accuracy. In addition, the relative positional accuracy between the lens array 12 as well as the image sensor 13 and the image pickup lens 11, and the formation accuracy of the microlens 12a are also desirably within a tolerance range. For example, when one microlens 12a is allocated to the matrix region U of 3×3, the image sensor 13 and the lens array 12 are desirably aligned with accuracy of a submicron order for the following region.

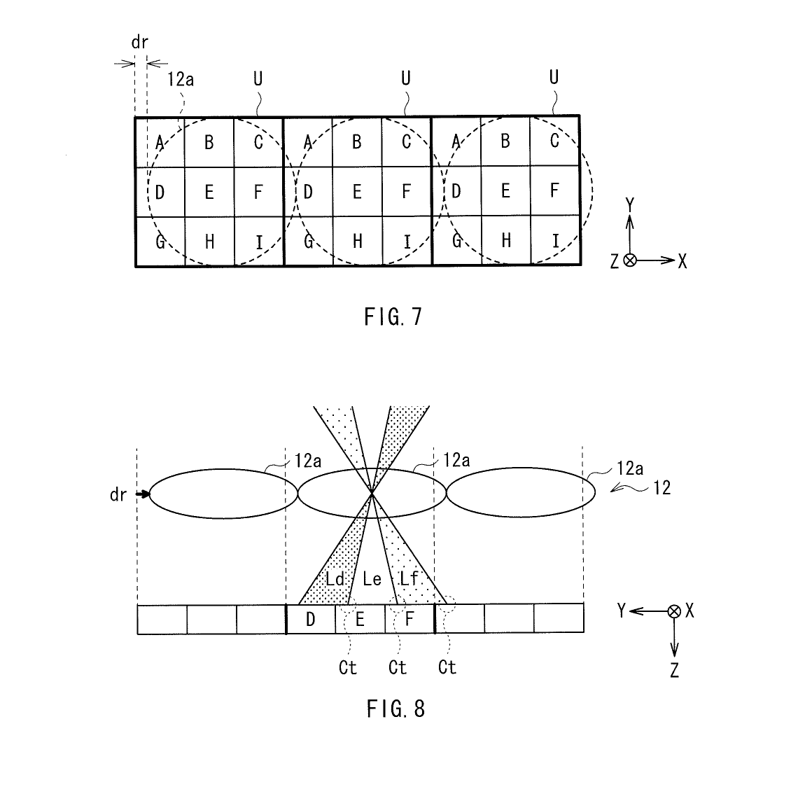

For example, as illustrated in FIG. 7, when relative displacement (dr) along the X direction occurs between the matrix region U and the microlens 12a, light beams corresponding to different perspectives are actually received by one pixel, and signals of different perspective components are mixed in each pixel signal. Specifically, as illustrated in FIG. 8, light beams Ld, Le, and Lf of three perspective components are received not only by corresponding pixels D, E, and F, respectively, but a part of each of the light beams Ld, Le, and Lf is received by respective adjacent pixels. For example, a part of the light beam Ld which is intended to be received by the pixel D is received by the pixel E. If the crosstalk between perspectives (Ct) occurs, image quality deterioration such as double image of the subject may occur in perspective images generated by the image processing section 14. Considering the mass-productivity and the like, however, it is difficult to ensure the relative positional accuracy between the image sensor 13 and the lens array 12 in submicron order in order to prevent the above-described displacement.

In the embodiment, before image processing operation by the image processing section 14 (before generation of the perspective images), crosstalk correction processing described below is performed on the image pickup signal D0 output from the image sensor 13.

[Correction of Crosstalk Between Perspectives]

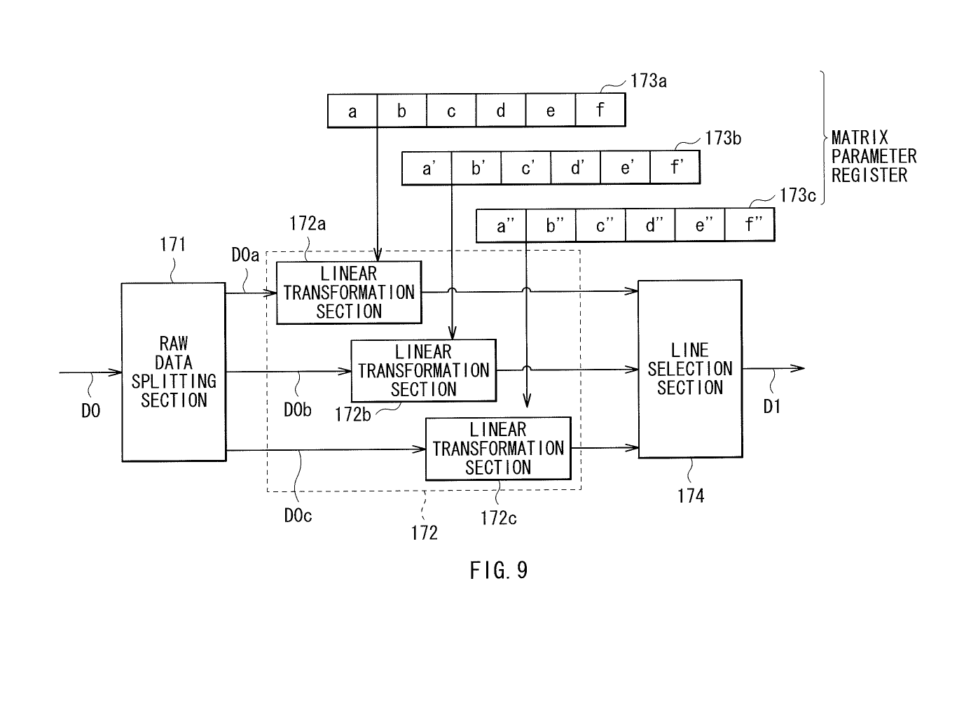

FIG. 9 illustrates a functional block configuration of the CT correction section 17. The CT correction section 17 includes, for example, a RAW data splitting section 171, an operation section 172, a matrix parameter register 173, and a line selection section 174. Incidentally, in the embodiment, description is given of the case where relative displacement along the X direction occurs between the lens array 12 and the image sensor 13, and the linear transformation is performed on the set of the pixel signals arranged along the X direction in the image pickup signal D0.

The RAW data splitting section 171 is a processing circuit splitting the image pickup signal D0 which is configured of the pixel signals obtained from the pixels A to I into a plurality of line signals. For example, as illustrated in FIG. 4, the RAW data splitting section 171 splits the image pickup signal D0 into line signals D0a (A, B, C, A, B, C, . . . ), D0b (D, E, F, D, E, F, . . . ), and D0c (G, H, I, G, H, I, . . . ) for three lines, and outputs the line signals D0a, D0b, and D0c to the operation section 172.

The operation section 172 includes linear transformation sections 172a, 172b, and 172c, and performs predetermined linear transformation on a set of the pixel signals obtained from a part or all of pixels in the matrix region U, in each of the line signals D0a, D0b, and D0c. Each of the linear transformation sections 172a, 172b, and 172c has a representation matrix corresponding to the input line signals D0a, D0b, and D0c, respectively. A square matrix including the number of dimensions equal to or lower than the number of pixels in the row direction and the column direction of the matrix region U is used as the representation matrix. For example, a three-dimensional or two-dimensional square matrix is used with respect to the matrix region U having the pixel arrangement of 3×3. Incidentally, when a two-dimensional square matrix is used as the representation matrix, the linear transformation may be performed only on a part (a selective pixel region of 2×2) of the matrix region U of 3×3, or a pixel region of 2×2 may be formed while a block region configured of combined two or more pixels is regarded as one pixel.

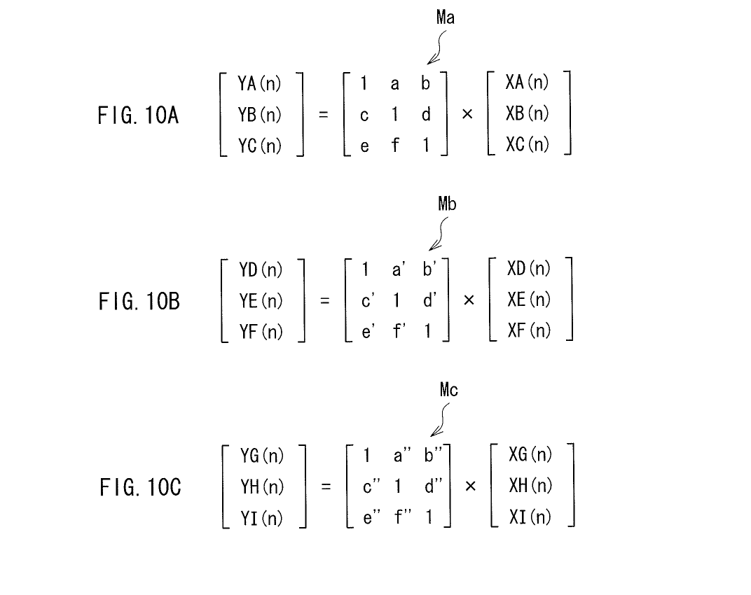

FIGS. 10A to 10C each illustrate an example of operation processing using a representation matrix. FIG. 10A illustrates linear transformation (linear transformation to the line signal D0a) to pixel signals of three pixels A, B, and C in the matrix region U. Likewise, FIG. 10B illustrates linear transformation (linear transformation to the line signal D0b) to pixel signals of pixels D, E, and F. FIG. 10C illustrates linear transformation (linear transformation to the line signal D0c) to pixel signals of the pixels G, H, and I. Note that in each figure, XA(n) to XI(n) are pixel signals (values of light receiving sensitivity) obtained from the pixels A to I, and YA(n) to YI(n) are corrected pixel signals (electric signals without crosstalk). In addition, the representation matrix of linear transformation to the set of pixel signals of the pixels A, B, and C is represented as Ma, the representation matrix of linear transformation to the set of pixel signals of the pixels D, E, and F is represented as Mb, and the representation matrix of linear transformation to the set of pixel signals of the pixels G, H, and I is represented as Mc.

The representation matrices Ma, Mb, and Mc are each formed of a three-dimensional square matrix (a square matrix of 3×3), and each have a diagonal component set to “1”. Components other than the diagonal component in each of the representation matrices Ma, Mb, and Mc are set to appropriate values as matrix parameters. Specifically, the matrix parameters (a, b, c, d, e, f), (a′, b′, c′, d′, e′, f′), and (a″, b″, c″, d″, e″, f″) of the representation matrices Ma, Mb, and Mc are held in matrix parameter registers 173a, 173b, and 173c, respectively. The matrix parameters a to f, a′ to f′, and a″ to f″ are held in advance as specified values depending on the relative positional accuracy between the image sensor 13 and the lens array 12, the relative positional relationship between the image pickup lens 11 and the image sensor 13 as well as the lens array 12, the formation accuracy of the microlens 12a, and the like. Alternatively, such matrix parameters may be input externally through a control bus (not shown). In the case of being externally input, the matrix parameters are allowed to be set by, for example, a PC connected to the outside with use of camera control software. Accordingly, for example, calibration by user is allowed, and appropriate correction is achievable even if displacement of each member or deformation of lens shape occurs due to usage environment, age-related deterioration, and the like.

[Derivation of Representation Matrices and Matrix Parameters]

Herein, derivation of the representation matrices Ma, Mb, and Mc as described above is described by taking the representation matrix Mb as an example. In other words, deviation of the expression of the linear transformation illustrated in FIG. 10B is described. Incidentally, herein, it is assumed the case where the relative displacement between the image sensor 13 and the lens array 12 occurs only along the X direction.

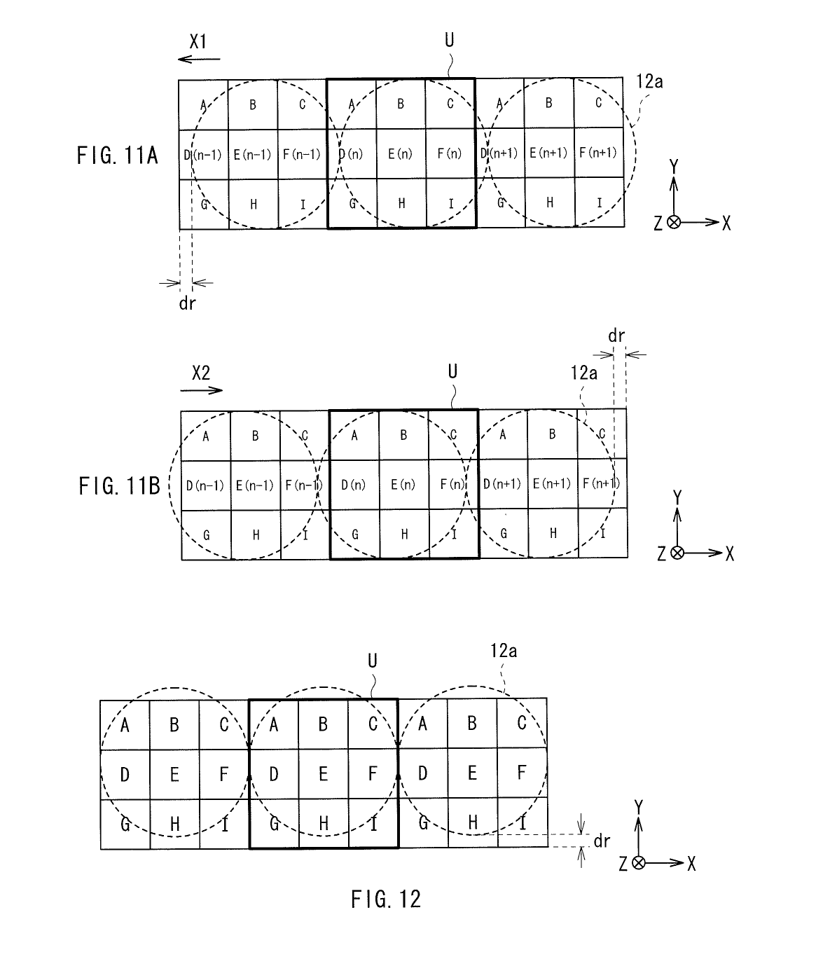

FIGS. 11A and 11B each schematically illustrate the relative displacement between the image sensor 13 and the lens array 12. FIG. 11A illustrates a case where the image sensor 13 shifts in a negative direction of the X direction (X1) with respect to the lens array 12, and FIG. 11B illustrates a case where the image sensor 13 shifts in a positive direction of the X direction (X2) with respect to the lens array 12. In each figure, the pixels D, E, and F arranged in a central line of three lines along the X direction in a certain matrix region U are referred to as D(n), E(n), and F(n), and the pixels D, E, and F in matrix regions U adjacent thereto are referred to as D(n−1), E(n−1), and F(n−1), and D(n+1), E(n+1), and F(n+1).

As illustrated in FIG. 11A, first, in the case where the image sensor 13 is displaced in the negative direction of the X direction, pixel signals XD(n), XE(n), and XF(n) output from the pixels D(n), E(n), and F(n), respectively, are represented by the following expressions (1) to (3), in consideration of the crosstalk caused by the displacement. Incidentally, α₁, α₂, and α₃ are coefficients each indicating a ratio of light beams corresponding to different perspectives mixed in the light beam from intended perspective (the amount of crosstalk), and 0<α₁, α₂, α₃<<1 is established. For example, a sample image is captured, and luminance is measured at some portions of a double image (an actual image and a virtual image caused by the crosstalk) in the captured sample image to calculate a ratio of an average of the measurement values (a luminance average value). Then, the coefficients α₁, α₂, and α₃ are allowed to be set for each pixel based on the ratio of the luminance average value.

XD(n)=YD(n)+α₁·YF(n−1) (1)

XE(n)=YE(n)+α₂·YD(n) (2)

XF(n)=YF(n)+α₃·YE(n) (3)

These expressions (1) to (3) are deformed so that YD(n), YE(n), and YF(n) are represented with use of a term of X. For example, although YD(n) is represented by the expression (4), a term (YF(n−1)) of Y in the expression (4) is deleted with use of the expression (3), and thus an expression (5) is established. In addition, a term (YE(n−1)) of Y in the expression (5) is deleted with use of the expression (2), and thus an expression (6) is established.

YD(n)=XD(n)−α₁·YF(n−1) (4)

YD(n)=XD(n)−α₁·{XF(n−1)−α₃YE(n−1)} (5)

YD(n)=XD(n)−α₁·[XF(n−1)−α₃·{XE(n−1)−α2·YD(n−1)}] (6)

Herein, the coefficients α₁, α₂, and α₃ are regarded as values extremely smaller than 1 (α₁, α₂, α₃<<1), and thus it is possible to take no account of (approximate by 0 (zero)) a terms of cube or more of the coefficients. Accordingly, YD(n) is represented by the following expression (7). YE(n) and YF(n) are also represented by the following expressions (8) and (9) through similar deformation with use of the expressions (1) to (3).

YD(n)=XD(n)−α₁·XF(n−1)+α₁ α₃·XE(n−1) (7)

YE(n)=XE(n)−α₂·XD(n)+α₁·α₂·XF(n−1) (8)

YF(n)=XF(n)−α₃·XE(n)+α₂·α₃·XD(n) (9)

Likewise, as illustrated in FIG. 11B, in the case where the image sensor 13 is displaced in the positive direction of the X direction, YF(n), YE(n), and YD(n) are represented by the following expressions (10) to (12), respectively.

YF(n)=XF(n)−β₁·XD(n+1)+β₁·β₃·XE(n+1) (10)

YE(n)=XE(n)−β₂·XF(n)+β₁·β₂·XD(n+1) (11)

YD(n)=XD(n)−β₃·XE(n)+β₂·β₃·XF(n) (12)

Then, assuming that the pixel values between adjacent pixels are substantially equal to each other, terms of Xx(n−1) and Xx(n+1) are both handled as Xx(n) without distinction. Therefore, YD(n) is represented by the following expression (13) from the expressions (7) and (12). Likewise, YE(n) is represented by the following expression (14) from the expressions (8) and (11), and YF(n) is represented by the following expression (15) from the expressions (9) and (10).

YD(n)=XD(n)−(β₃−α₁·α₃)XE(n)−(α₁−β₂·β₃)XF(n) (13)

YE(n)=−(α₂−β₁·β₂)XD(n)+XE(n)−(β₂−α₁·α₂)XF(n) (14)

YF(n)=−(β₁−α₂·α₃)XD(n)−(α₃−β₁·β₃)XE(n)+XF(n) (15)

These expressions (13) to (15) correspond to the expressions of the linear transformation illustrated in FIG. 10B. Incidentally, the matrix parameters (a′, b′, c′, d′, e′, f′) in FIG. 10B are represented as follows.

a′=α₁·α₃−β₃

b′=β₂·β₃−α₁

c′=β₁·β₂−α₂

d′=α₁·α₂−β₂

e′=α₂·α₃−β₁

f′=β₁·β₃−α₃

Note that the expressions (13) to (15) are effective also in the case where the displacement occurs in the Z direction or in the case of defective formation of the lens. Alternatively, in the case where the displacement occurs only in one direction, the expressions (7) to (9) or the expressions (10) to (12) may be used depending on the direction of the displacement. The direction of the displacement is, for example, allowed to be determined from the direction of a virtual image generated with respect to an actual image in a double image (the actual image and the virtual image caused by the crosstalk) of each perspective image based on a captured sample image. For example, in the case where the displacement occurs in the X1 direction, the matrix parameters (a′, b′, c′, d′, e′, f′) are represented as follows.

a′=α₁·α₃

b′=−α₁

c′=−α₂

d′=α₁·α₂

e′=α₂·α₃

f′=−α₃

Alternatively, in the case where the displacement occurs in the X2 direction, the matrix parameters (a′, b′, c′, d′, e′, f′) are represented as follows.

a′=−β₃

b′=β₂·β₃

c′=β₁·β₂

d′=−β₂

e′=−β₁

f′=β₁·β₃

By the procedures described above, the representation matrix Mb and the matrix parameters a′ to f for correcting the pixel signals in the pixels D, E, and F are allowed to be set. Moreover, focusing on the other pixel lines, it is possible to set the representation matrices Ma and Mc, and the matrix parameters a to f and a″ to f″ through the derivation procedures similar to those described above. Incidentally, if the correction is not necessary, a part or all of the matrix parameters a to f, a′ to f′, and a″ to f″ may be set to 0 (zero).

With use of the representation matrices Ma, Mb, and Mc thus set, the operation section 172 (the linear transformation sections 172a to 172c) performs linear transformation on a part of the pixel signals (herein, a set of three pixel signals arranged along the X direction) of the image pickup signal D0. For example, the linear transformation section 172b multiplies the pixel signals (XD(n), XE(n), and XF(n)) obtained from the three pixels (D, E, and F) in the central line by the representation matrix Mb to calculate the pixel signals (YD(n), YE(n), and YF(n)) after removing crosstalk. Likewise, the linear transformation section 172a multiplies the pixel signals (XA(n), XB(n), and XC(n)) of the pixels (A, B, and C) by the representation matrix Ma to calculate the pixel signals (YA(n), YB(n), and YC(n)) after removing crosstalk. Likewise, the linear transformation section 172c multiplies the pixel signals (XG(n), XH(n), and XI(n)) of the pixels (G, H, and I) by the representation matrix Mc to calculate the pixel signals (YG(n), YH(n), and YI(n)) after removing crosstalk.

By performing the above-described processing successively for every three pixels in each line, adjacent pixel information obtained mixedly in a certain pixel is removed, and the information is returned to the corresponding pixel at the same time. In other words, line signals D1a, D1b, and D1c in which perspective splitting is favorably performed in a pixel unit (the crosstalk between perspectives is reduced) are obtainable. The line signals D1a, D1b, and D1c are output to the line selection section 174.

The line selection section 174 rearranges, to one line, the line signals D1a, D1b, and D1c which are output from the linear transformation sections 172a, 172b, and 172c of the operation section 172, respectively, and then outputs the resultant signal. The line signals D1a, D1b, and D1c for three lines are converted into a line signal for one line (the image pickup signal D0 by the line selection section 174, and then the line signal for one line is output to the subsequent image processing section 14. In the image processing section 14, the above-described image processing is performed based on the corrected image pickup signal D1 to generate a plurality of perspective images.

As described above, in the embodiment, the light beam which has passed through the image pickup lens 11 is split into the light beams corresponding to the plurality of perspectives by the lens array 12, and then received by the pixels of the image sensor 13. As a result, the pixel signals based on the amount of received light are obtained. Even in the case where the relative displacement between the image sensor 13 and the lens array 12 occurs, the crosstalk between perspectives is suppressed with use of a part or all of the pixel signals output from the respective pixels, and thus, the perspective splitting is performed with high accuracy in a pixel unit. Therefore, the image quality deterioration caused by the crosstalk between perspectives is allowed to be reduced. As a result, even in the case where the alignment accuracy between the image sensor 13 and the lens array 12 in which the microlenses are formed in a submicron order is not sufficient, the image quality deterioration caused by the crosstalk is reduced. This leads to improvement in mass-productivity, and suppresses investment for new manufacturing facilities. In addition, since it is possible to correct not only crosstalk caused by optical displacement, defective formation of the lens, and the like in manufacturing, but also crosstalk caused by age-related deterioration, impact, and the like, higher reliability is allowed to be maintained.

Incidentally, in the above-described embodiment, the CT correction section 17 performs the crosstalk correction with use of all of the pixel signals by performing the linear transformation on the image pickup signal D0 for each line along the X direction. However, all of the pixel signals are not necessarily used. For example, in the embodiment, as described above, perspective images for the number of (nine, herein) pixels in the matrix region U are allowed to be generated based on the image pickup signal D1. For the stereoscopic display, however, two perspective images of left and right are only necessary and all of nine perspective images are not necessary in some cases. In such a case, the linear transformation may be performed only on the central line including the pixel signals of a part of pixels (for example, the pixels D and F for obtaining the left and right perspective images) in the matrix region U.

Hereinafter, a crosstalk correction method according to modifications (modifications 1 and 2) of the embodiment is described. In the modifications 1 and 2, similarly to the above-described embodiment, in the image pickup unit 1 including the image pickup lens 11, the lens array 12, the image sensor 13, the image processing section 14, the image sensor driving section 15, the CT correction section 17, and the control section 16, the CT correction section 17 performs the linear transformation focusing on a pixel different from that in the above-described embodiment. Note that like numerals are used to designate substantially like components in the above-described embodiment, and the description thereof is appropriately omitted.

[Modification 1]

FIG. 12 illustrates relative displacement between the lens array 12 (microlenses 12a) and the image sensor 13 according to the modification 1. In the modification 1, unlike the above-described embodiment, it is assumed that the relative displacement dr between the lens array 12 and the image sensor 13 occurs along the Y direction. When the displacement dr occurs along the Y direction, the linear transformation is performed on a set of the pixel signals obtained from the pixels which are arranged along the Y direction, in the matrix region U. Note that it is possible to determine whether the displacement occurs in the X direction or the Y direction, from the direction of a virtual image generated with respect to an actual image in a double image (the actual image and the virtual image caused by the crosstalk) of each perspective image based on a captured sample image. The direction along which the correction is performed may be held in advance or may be set by an externally-input signal.

Also in the modification 1, similarly to the above-described embodiment, the CT correction section 17 has the functional structure as illustrated in FIG. 9, and includes the RAW data splitting section 171, the operation section 172, the matrix parameter register 173, and the line selection section 174. Incidentally, in the case where the signals are read out from the image sensor 13 in a line basis along the X direction as described above, the following configuration is necessary. In the modification 1, the linear transformation is performed on the pixel signals arranged along the Y direction. Therefore, unlike the above-described embodiment, a buffer memory (not shown) temporarily holding line signals for three lines is necessary to be provided. Accordingly, for example, by providing such a buffer memory between the RAW data splitting section 171 and the operation section 172 or in the operation section 172, and using the line signals for three lines held in the buffer memory, the linear transformation is performed on a set of the pixel signals arranged along the Y direction.

Specifically, the operation section 172 performs, based on the line signals for three lines described above, the linear transformation on the sets of the respective pixel signals obtained from the respective three pixels (A, D, G), (B, E, H), and (C, F, I) which are arranged along the Y direction in the matrix region U. Also in the modification 1, the operation section 172 includes three linear transformation sections corresponding to the sets of the pixel signals, and holds the representation matrices (representation matrices Md, Me, and Mf described later) for respective linear transformation sections. As the representation matrix, used is a square matrix having the number of dimensions equal to or lower than the number of pixels in the row direction and the column direction of the matrix region U, similarly to the case of the above-described embodiment.

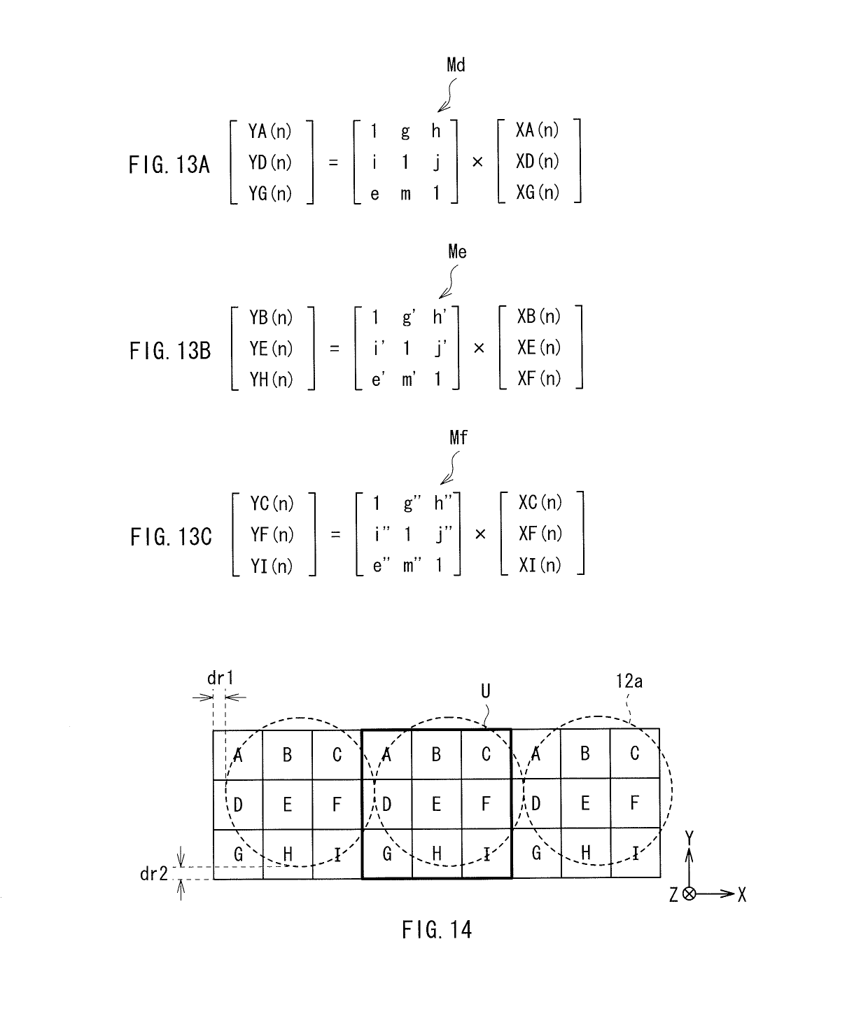

FIGS. 13A to 13C each illustrate an example of the operation processing with use of the representation matrix according to the modification 1. FIG. 13A illustrates the linear transformation to the pixel signals of three pixels A, D, and G in the matrix region U. Likewise, FIG. 13B illustrates the linear transformation to the pixel signals of pixels B, E, and H, and FIG. 13C illustrates the linear transformation to the pixel signals of pixels C, F, and I. Note that in each figure, XA(n) to XI(n) are pixel signals (values of light receiving sensitivity) obtained from the pixels (pixel sensors) A to I, and YA(n) to YI(n) are corrected pixel signals (electric signals without crosstalk). In addition, the representation matrix of the linear transformation to the set of the pixel signals of the pixels A, D, and G is represented as Md, the representation matrix of the linear transformation to the set of the pixel signals of the pixels B, E, and H is represented as Me, and the representation matrix of the linear transformation to the set of the pixel signals of the pixels C, F, and I is represented as Mf.

The representation matrices Md, Me, and Mf are each formed of a three-dimensional square matrix (a matrix of 3×3) similarly to the representation matrices Ma, Mb, and Mc of the above-described embodiment, and each have a diagonal component set to “1”. Moreover, components other than the diagonal component in each of the representation matrices Md, Me, and Mf are set to appropriate values as matrix parameters. Specifically, the matrix parameters (g, h, i, j, k, m), (g′, h′, 1′, j′, k′, m′), and (g″, h″, i″, j″, k″, m″) of the representation matrices Md, Me, and Mf are held in matrix parameter registers 173a, 173b, and 173c, respectively. The matrix parameters g to m, g′ to m′, and g″ to m″ are held in advance as specified values depending on the relative positional accuracy between the image sensor 13 and the lens array 12, and the like, or are externally input, similarly to the matrix parameters in the above-described embodiment. Incidentally, also in the modification 1, the representation matrices Md, Me, and Mf and the matrix parameters g to m, g′ to m′, and g″ to m″ described above are allowed to be derived in a manner similar to that in the above-described embodiment.

In the modification 1, the linear transformation is performed on a part of the pixel signals (the set of three pixel signals arranged along the Y direction) of the image pickup signal D0 with use of the representation matrices Md, Me, and Mf. For example, the pixel signals (XA(n), XD(n), and XG(n)) obtained from the three pixel sensors (A, D, and G) are multiplied by the representation matrix Md to calculate the pixel signals (YA(n), YD(n), and YG(n)) after removing crosstalk. Likewise, the pixel signals (XB(n), XE(n), and XH(n)) obtained from the pixels (B, E, and H) are multiplied by the representation matrix Me to calculate the pixel signals (YB(n), YE(n), and YH(n)) after removing crosstalk. Likewise, the pixel signals (XC(n), XF(n), and XI(n)) obtained from the pixels (C, F, and I) are multiplied by the representation matrix Mf to calculate the pixel signals (YC(n), YF(n), and YI(n)) after removing crosstalk.

By performing the above-described processing successively for every three pixels arranged along the Y direction, adjacent pixel information obtained mixedly in a certain pixel is eliminated, and the information is returned to the corresponding pixel at the same time. In other words, the image pickup signal D1 in which perspective splitting is favorably performed in a pixel unit (the crosstalk between perspectives is reduced) is obtainable. Therefore, also in the modification 1, even in the case where the relative displacement between the image sensor 13 and the lens array 12 occurs, the crosstalk between perspectives is suppressed with use of a part or all of the pixel signals output from the respective pixels, and the perspective splitting is performed with high accuracy in a pixel unit. Consequently, effects equivalent to those in the above-described embodiment are obtainable.

[Modification 2]

FIG. 14 illustrates relative displacement between the lens array 12 (microlenses 12a) and the image sensor 13 according to the modification 2. In the modification 2, unlike the above-described embodiment, the relative displacement dr between the lens array 12 and the image sensor 13 occurs not only in the X direction but also in the Y direction. In the case where the displacement dr occurs along an XY plane, in the matrix region U, the linear transformation to the set of the pixel signals obtained from the pixels arranged along the X direction and the linear transformation to the set of the pixel signals obtained from the pixels arranged along the Y direction are sequentially performed.

Also in the modification 2, similarly to the above-described embodiment, the CT correction section 17 has the functional structure as illustrated in FIG. 9, and includes the RAW data splitting section 171, the operation section 172, the matrix parameter register 173, and the line selection section 174. Moreover, in the case where the signals are read out from the image sensor 13 in a line basis along the X direction, the CT correction section 17 further includes a buffer memory (not shown) temporarily holding line signals for three lines since the linear transformation to the pixel signals arranged along the Y direction is included, similarly to the modification 1.

Specifically, in a manner similar to that in the above-described embodiment, as illustrated in FIGS. 10A to 10C, the operation section 172 performs the linear transformation on the set of the three pixel signals arranged along the X direction of the image pickup signal D0, with use of the representation matrices Ma, Mb, and Mc. For example, the pixel signals (XD(n), XE(n), and XF(n)) obtained from the three pixels (D, E, and F) are multiplied by the representation matrix Mb to calculate the pixel signals (YD(n), YE(n), and YF(n)) after removing crosstalk. Likewise, the pixel signals (XA(n), XB(n), and XC(n)) obtained from the pixels (A, B, and C) are multiplied by the representation matrix Ma to calculate the pixel signals (YA(n), YB(n), and YC(n)) after removing crosstalk. Likewise, the pixel signals (XG(n), XH(n), and XI(n)) obtained from the pixels (G, H, and I) are multiplied by the representation matrix Mc to calculate the pixel signals (YG(n), YH(n), and YI(n)) after removing crosstalk.

Subsequently, in a manner similar to that in the above-described modification 1, as illustrated in FIGS. 13A to 13C, the linear transformation is performed on the set of the three pixel signals arranged along the Y direction of the image pickup signal D0, with use of the representation matrices Md, Me, and Mf. For example, the pixel signals (XA(n), XD(n), and XG(n)) obtained from the three pixels (A, D, and G) are multiplied by the representation matrix Md to calculate the pixel signals (YA(n), YD(n), and YG(n)) after removing crosstalk. Likewise, the pixel signals (XB(n), XE(n), and XH(n)) obtained from the pixels (B, E, and H) are multiplied by the representation matrix Me to calculate the pixel signals (YB(n), YE(n), and YH(n)) after removing crosstalk. Likewise, the pixel signals (XC(n), XF(n), and XI(n)) obtained from the pixels (C, F, and I) are multiplied by the representation matrix Mf to calculate the pixel signals (YC(n), YF(n), and YI(n)) after removing crosstalk.

As described above, the linear transformation to the set of the pixel signals along the X direction and the linear transformation to the set of the pixel signals along the Y direction are successively performed, and therefore, even in the case where the displacement (dr1 and dr2) occurs in the XY plane, adjacent pixel information obtained mixedly in a certain pixel is removed and the information is returned to the corresponding pixel. In other words, the image pickup signal D1 in which the perspective splitting is favorably performed in a pixel unit (the crosstalk between perspectives is reduced) is obtainable. Accordingly, also in the modification 2, even in the case where the relative displacement between the image sensor 13 and the lens array 12 occurs, the crosstalk between perspectives is suppressed with use of a part or all of the pixel signals output from the respective pixels, and the perspective splitting is allowed to be performed with high accuracy in a pixel unit. As a result, effects equivalent to those in the above-described embodiment are obtainable.

Note that in the above-described modification 2, the linear transformation to the set of the pixel signals along the X direction is performed, and then the linear transformation to the set of the pixel signals along the Y direction is performed. Alternatively, the order of the linear transformation may be reversed. In other words, the linear transformation to the set of the pixel signals along the Y direction is performed, and then the linear transformation to the set of the pixel signals along the X direction may be performed. Alternatively, the order of the linear transformation may be set in advance or may be set by an externally-input signal. In any of these cases, the linear transformation is successively performed so that crosstalk between perspectives caused by the displacement along each direction is allowed to be suppressed.

Hereinbefore, although the disclosure has been described with referring to the embodiment and the modifications, the disclosure is not limited thereto, and various modifications may be made. For example, in the above-described embodiment, although the description is given of the case where the number of pixels (the matrix region U) allocated to one microlens is nine (=3×3), the matrix region U is not limited thereto. The matrix region U may be configured of the arbitrary m×n pieces (m and n are each an integer of 1 or larger, except for m=n=1) of pixels, and m and n may be different from each other.

Moreover, in the embodiment and the like, the lens array is exemplified as a perspective splitting device. However, the perspective splitting device is not limited to the lens array as long as the device is capable of splitting the perspective components of a light beam. For example, the configuration in which a liquid crystal shutter which is divided into a plurality of regions in the XY plane and is capable of switching open and closed states in each region is disposed as a perspective splitting device between the image pickup lens and the image sensor is available. Alternatively, a perspective splitting device having a plurality of holes, that is, so-called pin-holes, in the XY plane is also available.

Furthermore, in the embodiment and the like, the unit including the image processing section which generates perspective images is described as an example of the image pickup unit of the disclosure. However, the image processing section is not necessarily provided.

Note that the disclosure may be configured as follows.

(1) An image pickup unit including:

an image pickup lens;

a perspective splitting device splitting a light beam that has passed through the image pickup lens into light beams corresponding to a plurality of perspectives different from one another;

an image pickup device having a plurality of pixels, and receiving the light beams that have passed through the perspective splitting device, by each of the pixels, to obtain pixel signals based on an amount of the received light; and

a correction section performing correction for suppressing crosstalk between perspectives with use of a part or all of the pixel signals obtained from the plurality of pixels.

(2) The image pickup unit according to (1), wherein the correction section performs linear transformation on a set of two or more pixel signals to perform the correction.

(3) The image pickup unit according to (1) or (2), wherein

the perspective splitting device is a lens array, and

light beams that have passed through one lens of the lens array are received by a unit region, the unit region being configured of two or more of the pixels of the image pickup device.

(4) The image pickup unit according to (3), wherein the correction section performs the linear transformation on a set of pixel signals output from a part or all of the pixels in the unit region.

(5) The image pickup unit according to (3) or (4), wherein the unit region includes two or more pixels arranged two-dimensionally in a matrix, and

the correction section uses, as a representation matrix for the linear transformation, a square matrix having number of dimensions equal to or lower than number of the pixels in a row direction or a column direction in the unit region.

(6) The image pickup unit according to any one of (3) to (5), wherein each component of the representation matrix is set in advance based on relative displacement between the unit region and the microlens, or is settable based on an externally-input signal.

(7) The image pickup unit according to (5) or (6), wherein a diagonal component of the representation matrix is 1.

(8) The image pickup unit according to any one of (3) to (7), wherein the correction section performs the linear transformation on one of a set of pixel signals obtained from pixels arranged in the row direction in the unit region and a set of pixel signals obtained from pixels arranged in the column direction in the unit region, or performs the linear transformation once successively on both the sets.

(9) The image pickup unit according to any one of (3) to (8), wherein selection or order selection of the row direction and the column direction of the pixel signals subjected to the linear transformation is set in advance or is settable based on an externally-input signal.

(10) The image pickup unit according to any one of (1) to (9), further including an image processing section performing image processing based on pixel signals corrected by the correction section.

(11) The image pickup unit according to any one of (1) to (10), wherein the image processing section performs rearrangement on an image pickup signal including the corrected pixel signals to generate a plurality of perspective images.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An image pickup unit comprising:
an image pickup lens;
a perspective splitting device splitting a light beam that has passed through the image pickup lens into light beams corresponding to a plurality of perspectives different from one another;
an image pickup device having a plurality of pixels, and receiving the light beams that have passed through the perspective splitting device, by each of the pixels, to obtain pixel signals based on an amount of the received light; and
a correction section performing correction for suppressing crosstalk between perspectives with use of a part or all of the pixel signals obtained from the plurality of pixels.

2. The image pickup unit according to claim 1, wherein the correction section performs linear transformation on a set of two or more pixel signals to perform the correction.

3. The image pickup unit according to claim 2, wherein
the perspective splitting device is a lens array, and
light beams that have passed through one lens of the lens array are received by a unit region, the unit region being configured of two or more of the pixels of the image pickup device.

4. The image pickup unit according to claim 3, wherein the correction section performs the linear transformation on a set of pixel signals output from a part or all of the pixels in the unit region.

5. The image pickup unit according to claim 4, wherein
the unit region includes two or more pixels arranged two-dimensionally in a matrix, and
the correction section uses, as a representation matrix for the linear transformation, a square matrix having number of dimensions equal to or lower than number of the pixels in a row direction or a column direction in the unit region.

6. The image pickup unit according to claim 5, wherein each component of the representation matrix is set in advance based on relative displacement between the unit region and the microlens, or is settable based on an externally-input signal.

7. The image pickup unit according to claim 6, wherein a diagonal component of the representation matrix is 1.

8. The image pickup unit according to claim 5, wherein the correction section performs the linear transformation on one of a set of pixel signals obtained from pixels arranged in the row direction in the unit region and a set of pixel signals obtained from pixels arranged in the column direction in the unit region, or performs the linear transformation once successively on both the sets.

9. The image pickup unit according to claim 8, wherein selection or order selection of the row direction and the column direction of the pixel signals subjected to the linear transformation is set in advance or is settable based on an externally-input signal.

10. The image pickup unit according to claim 1, further comprising an image processing section performing image processing based on pixel signals corrected by the correction section.

11. The image pickup unit according to claim 10, wherein the image processing section performs rearrangement on an image pickup signal including the corrected pixel signals to generate a plurality of perspective images.
